(19) United States
(12) Patent Application Publication
(10) Pub. No.: US 2004/0193872 A1
(43) Pub. Date: Sep. 30, 2004

(54) System and method for renewing and extending digitally signed certificates

(76) Inventors: Mart Saarepera, Tallinn (EE); Ahto Buldas, Tallinn (EE)

Correspondence Address: James P Muraff, Wallenstein Wagner & Rockey, 53rd Floor, 311 South Wacker Drive, Chicago, IL, 60606-6630, US

(21) Appl. No.: 10/483,216

(22) PCT Filed: Jul. 3, 2002
(86) PCT No.: PCT/IB02/02643

Related U.S. Application Data
(60) Provisional application No. 60/303,951, filed on Jul. 9, 2001.

(51) Int. Cl. H04L 9/00

(52) U.S. Cl. 713/156

(57) ABSTRACT

A system, method, and computer program product is provided for generating new digitally signed statements (certificates). The generated new certificates can be used within a renewal procedure for compromised signatures. The generated new certificates can also be used within an extension procedure for adding new signatures to existing certificates. The system, method, and computer program product can generate new certificates by receiving an initial list of certificates comprising a plurality of certificates, verify the authenticity of each of the plurality of certificates, compute a new certificate using a composition algorithm, sign the new certificate, revise the list of certificates, and attach the list, as revised, to the new certificate.

### TECHNICAL FIELD

The present invention generally relates to electronically signing statements. More particularly, the present invention relates to using electronically signed statements to authenticate the identity of people and/or things, and to authenticate a time relating to a transaction to be sent over an electronic communication network.

### BACKGROUND OF THE INVENTION

Digital signatures are used for electronic documents in a similar way that handwritten signatures are used for printed documents. They can be used for a variety of electronic transactions including email, electronic commerce, groupware, and electronic fund transfers.

One of the purposes of signing a document is an evidentiary function. The document holder (relying party) is able to prove later that the person who gave the signature agreed with the contents of the document. For example, after signing a promissory note, one creates evidence that is (in most cases) sufficient for the holder of the note to get his/her money back. For example, Alice lends Bob $100. In return, Bob signs a promissory note and gives it to Alice. Some months later, Alice shows Bob the promissory note to get her $100 back. If Alice loses the promissory note with Bob's signature on it, then Bob would be able to deny receiving any money from Alice and Alice would have no evidence to the contrary. However, if Alice takes good care of the promissory note then Bob is unable to deny that he owes Alice the money because the signature of Bob can be verified any time.

Today, more and more documents are created, managed and transmitted in electronic form. Cryptographic techniques can provide electronic documents with “signatures” that are created with secret cryptographic keys (known only to the signer) and verified with public keys (known to everybody). Without access to the secret key it is impossible to create a valid (successfully verified with the corresponding public key) cryptographic signature. The main concern with cryptographic signatures, however, is that there is no way to completely exclude the possibility that the secret key becomes public (revealed to other persons). After the leakage, signatures can be forged and it would be hard to distinguish between the “good” signatures given before the leakage and “bad” signatures given by hackers after the leakage. Turning back to the Alice and Bob case, suppose Bob uses cryptographic signature to sign the promissory note. If he is dishonest, he may “accidentally” reveal his signature key right after he signs the promissory note and later deny having received any money. If Alice comes up with the promissory note, Bob claims that Alice created the note herself by using the “accidentally” revealed key.

There are even more serious threats to cryptographic signatures that do not depend on the signer (Bob) or on the relying party (Alice). The mechanisms and algorithms of cryptographic signatures may become unreliable and insecure. Sooner or later, every cryptographic mechanism becomes insecure. We need some additional prevention or recovery measures against cryptographic signatures becoming invalid, otherwise electronic signatures would be useless.

The measures proposed to date are mostly preventive in nature. For example, Haber proposed a method of using nested cryptographic functions—before one cryptographic function (such as cryptographic signature) becomes insecure, another cryptographic function (e.g. signature with another key) is applied to the result of the first cryptographic function.

One way to fight against the weaknesses of cryptography is to set up a server (or a network of redundant servers) that stores all the statements signed by Bob (and by others as well). In that solution, cryptographic signatures are not needed. One may use passwords to authenticate Bob or others when they send to the server the documents they intended to sign. The only known solution to the problem is redundancy, using multiple cryptographic keys and methods to sign documents that confirm the same fact (e.g. “Bob owes Alice $100”). If one method or key becomes invalid, we still have a valid set keys and can prove the fact. Methods that use a list of digitally signed certificates to prove the same thing are well known. However, even the redundancy by itself is not enough to protect documents in long-term sense. All the components will eventually break one by one and the result is finally the same. We can no longer prove the fact.

The present invention is provided to solve these and other problems.

### SUMMARY OF THE INVENTION

The present invention is a method, system, and program for preserving the validity of proofs (of some fact or event) represented in a list of electronic certificates with cryptographic signatures. This method, system, and program enables the proofs to be verifiable for an indefinitely long time, even when cryptographic methods become insecure or keys compromised. In one embodiment, the contents of the certificates in the sent list are used as a trusted source of information to generate a new certificate. The new certificate becomes an additional member of the original list. Using such services, one is able to replace invalid certificates of a list with new certificates. As a result, the list of certificates with the additional new certificate confirms the fact within with equal strength. The quality of the new list as a proof will not degrade.

In one embodiment, the list of digitally signed certificates is first obtained from an electronic service S which, having received a query x from a client, answers with a digitally signed certificate Signₛ{A(x)}, where A(x) is a certain statement about x. For example, if x is a credit card number, A(x) may be a statement like “x was valid at t,” where t denotes time/date. Another example relates to digital time-stamping. There, the statement A(x) may say: “x was presented to S at t.” S may also issue statements such as “x is a citizen of the US,” etc.

After the digitally signed certificates are received by the client computer, one of the main concerns relate to the evidentiary value of those issued certificates. Digital signature schemes are not eternally secure because secret keys may leak or cryptographic algorithms broken. In one embodiment, if the key of S is compromised, S generates a new key and replaces the signatures created using the old key with signatures created using the new key. Such a renewing process makes sense only if, given a certificate signed by the old key, S is able to decide whether the certificate is (1) authentic—was indeed issued by S itself, or (2) counterfeit —was created by a malicious person who has gained access to the compromised key. If the service provider S has a database of all statements it has issued, then the authentic and counterfeit certificates are easy to distinguish. Sometimes, such databases are necessary for other reasons, so that using them for the renewing purpose would create no additional costs. However, for other services such as digital time-stamping, maintaining such a database seems like an unreasonable luxury. The service itself is almost “tateless.” The only state variable is the current time/date. Hence, there is no need to store the previously issued certificates because they have no influence to the behavior of the TSA in the future. However, an authentic list of previous certificates issued requires an expensive database and retrieval mechanism in case the signature key of the TSA is compromised.

To overcome the threats associated with broken cryptographic schemes and key compromise, a service consisting of a (distributed) network of servers S₁, . . . , Sₛ, create certificates that represent statements of the same type. For signing their statements, said servers may use different keys or signature schemes. If one of the keys or schemes become compromised, the certificates signed with the other keys or schemes remain authentic and can be used as trusted information to restore (renew) certificates created with the compromised scheme. For the renewal, a service consisting of a (distributed) network of renewal/extension servers R₁, . . . , Rᵣ, verify the signatures of S₁, . . . , Sₛ, and generate the new certificate. The renewal/extension service could be part of the service offered by S₁, . . . , Sₛ, or independently operated.

In one embodiment, the present invention is a method for renewing a list of digitally signed certificates. The method comprises at least the steps of 1) transmitting a sublist of an initial set of signed certificates to a set of renewal servers; 2) verification of cryptographic signatures on the certificates in the sublist; 3) combining the contents of the certificates in sublist and computing a new statement using a composition algorithm; 4) signing the new statement cryptographically; and 5) replacing the compromised certificate in the initial list with the new certificate.

In an alternative embodiment, the present invention is a method for extending a list of digitally signed certificates. The method comprises at least the steps of 1) transmitting a sublist of an initial set of signed certificates to a set of renewal servers; 2) verification of cryptographic signatures on the certificates in the sublist; 3) combining the contents of the certificates in sublist and computing a new statement using a composition algorithm; 4) signing the new statement cryptographically; and 5) adding the additional certificate to the initial list of certificates.

In another embodiment, the present invention is a system and method provided for renewing an unuseable certificate from a plurality of digitally signed certificates signed by a multitude of originating servers. The system and method in this embodiment comprises a set of originating servers, a user computer, and a set of renewal servers connected to a communications network. Moreover, upon an initial?.request from the user computer the set of originating servers issues one or more digital certificate for use in secured electronic transactions. Additionally, if one of the certificates becomes unuseable due to cryptographic key breach or certificate corruption, a list of the remaining valid certificates is sent to the renewal server. The renewal server first validates the signatures on the certificates using a set of public keys. Then, utilizing a computation algorithm, the renewal server takes the list of valid and authenticated certificates transmitted from the user computer and generates a new certificate. Prior to transmission of the new certificate back to the user computer, the statements are digitally signed by the renewal server and an updated list attached. The new certificate is sent back to the user computer and replaces the unuseable certificate, thus completing the renewal process.

For example, in an electronic time-stamping service S which, having received a query x, answers with a digitally signed certificate Signₛ{A(x)}, where A(x) is a statement about x of the form “x was presented to S at t”. The statement x may be Bob's signature on a promissory note. To obtain a certificate for x, Alice chooses n different servers and obtains n different certificates. If one of those certificates becomes invalid, Alice uses a renewal service implementing this invention's renewal method to obtain a new certificate. Alice chooses a sublist of certificates that are still valid and sends them to server. As a result, she obtains a new The content of the new certificate may be of the form “R confirms that x existed at t′,” where t′ is a function of the time values that the sublist of certificates comprises.

In another embodiment, the present invention is a system and method provided for certificate extension, that is extending a plurality of digitally signed certificates signed by a multitude of originating servers. The user interacting with a user computer may want to initiate this procedure to make the set of digital certificates more resistant to key compromise by extending the list by one more certificate. In this embodiment, rather than replacing an unuseable certificate on the user computer, the new certificate is added on to a list of n original certificates. The user computer now has n+1 digital certificates.

In another embodiment, the present invention is a certificate service system which implements the method of renewing or extending digitally signed certificates. The service contains a network of (distributed) servers of two kinds: a) certificate issuing servers and b) renewal/extension servers. A client computer prepares a request for a certificate and sends the request simultaneously to multiple certificate issuing servers. Each certificate issuing server issues a certificate upon the request and sends it to the client. The client receives said certificates and keeps them all in one directory. The client computer contains a program for verification of certificates. The client uses the certificate verification program frequently to be convinced that the certificates in the directory are valid. In case some of the certificates in the directory are no longer valid, the client computer removes the non-valid certificate, prepares a certificate renewal request, which contains all valid certificates in the said directory and sends it to one of the renewal/extension servers. The renewal/extension server issues a new certificate based on the client's request by using the method of the invention and sends the new certificate back to the client. The client computer puts the new certificate into the directory of certificates. In case the client discovers invalid certificates again it repeats the renewal procedure.

In a further embodiment, the present invention is a system, method, and product provided for certificate extension or renewal in a digital time-stamping service. Each digital time stamp issued by the Time-Stamping Server (TSA) has a statement “time/date.” Here, the computation algorithm may utilize the k-th smallest element of the argument list in generating the new certificate. The computation algorithm may also utilize the k-th largest element of the argument list in generating the new certificate. Other alternative service embodiments include, but are not limited to: public key certification services, digital signature services, certificate validation services, and electronic notary services.

The types of communication networks can include but are not limited to: ethernet, internet, intranet, wide area network, local area network, virtual private network, wireless, asynchronous transmission method, synchronous, dial-up, distributed, and other types.

Advantageously, with this invention, services may efficiently and cost effectively renew digital certificates that become unusable due to corruption or breach in the cryptographic key. To further enhance the security of the digital certificates, this invention also extends an existing group of digital certificates.

Other features and advantages of the invention will be apparent from the following specification taken in conjunction with the following drawings.

### BRIEF DESCRIPTION OF THE DRAWINGS

FIG. 1 is one system for modifying a group of certificates of the present invention as implemented within a computer network.

FIG. 2 is a message flow diagram within one system for modifying a group of certificates of the present invention.

FIG. 3 is a flow chart of one method of modifying of certificates of the present invention.

FIG. 4 is a block diagram of one system for modifying a group of certificates of the present invention.

FIG. 5 is another block diagram of one method of modifying a group of certificates of the present invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

This invention relates to a system, method and program for renewing digitally signed certificates without having to maintain a database of valid certificates. One embodiment of this invention uses a set of originating servers 111 which issue the same type of digital certificates 205. To obtain a certificate for a request x 201, a user chooses n different servers 116 and obtains n different certificates 204 . If one of these certificates becomes unusable, then an m-element (m<n) list of still valid certificates C(1), . . . C(m) 206 is sent to a renewal server R 114. A certificate becomes unusable when the key is compromised, the certificate is corrupt, or the cryptographic scheme is broken. We may assume without losing generality that the list of valid certificates is

C(1)=Signₛ(1){A₁(x)}, . . . , C(m) Signₛ(m){(Aₘ(x)}.

In case the signatures on these certificates are correct, R 114 issues a new certificate C(m+1)=Sign_{R}{A(x)}, such that

A(x)=F[A₁(x), . . . , Aₘ(x)],

where F 401 is a composition algorithm. The old certificate that was compromised is replaced with the new certificate C(m+1) 207 . If only one of the certificates in the list was compromised then the new list again n valid components and its resistance to key compromises is the same as that of the previous certificates. No database is needed in the procedure. In these cases where a digital certificate becomes unusable, the system, method, and program in this invention can renew the certificate by generating a new certificate. Another embodiment of this invention involves users who initiate the procedure to generate an additional digital certificate thereby extending the list by one more certificate. This certificate extension process has the effect of enhancing resistance to key compromise.

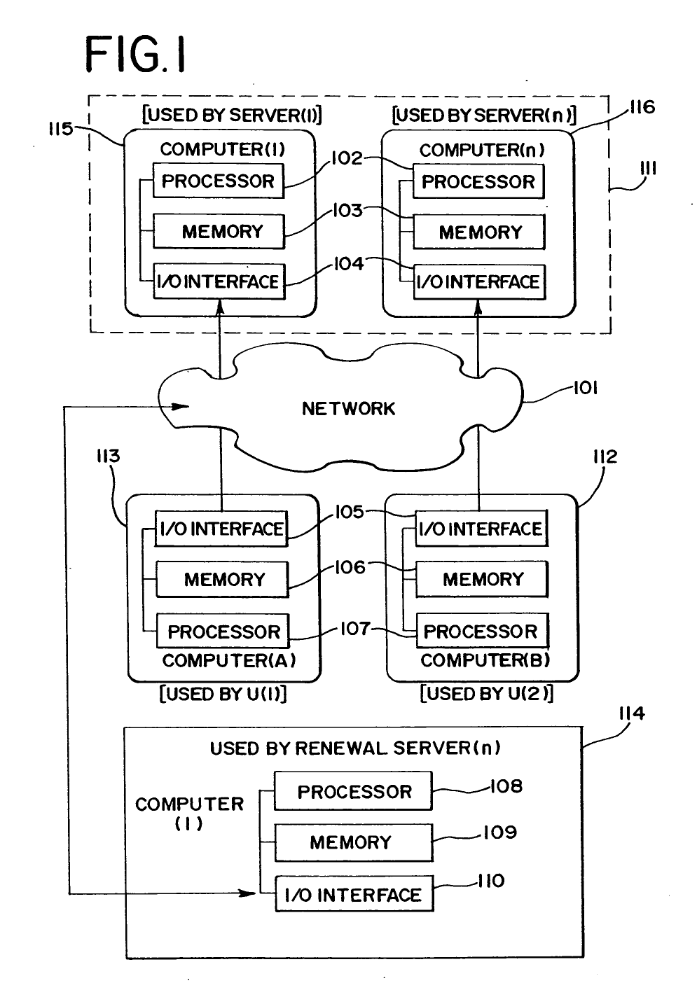

In FIG. 1, a computer 112, a conventional personal computer comprising an I/O interface 105 for interacting with a human user and accessing the network 101, a memory 106 for storing a group of digital certificates and other data to be described, and a processor 107 for requesting, receiving, and replacing digital certificates, is employed by a user to access a communications network 101. Also connected to the network is a group of originating server computers 111 and a renewal server 114. The group of originating server computers 111 is comprised of least two or more computers used to deliver the initial set of digital certificates to the user computer 112. The first server 115 and second server 116, out of a plurality of originating servers 111, is comprised of an I/O interface 104, a memory 106, and a processor 107 for creating an initial set of digital certificates. The renewal server 113 is comprised of at least one or more computers used to generate a new digital certificate based on a set of n valid certificates received from the user computer 112, where the computer has an I/O interface 110 for receiving and transmitting digital certificates, a memory 109 for storing the newly computed certificate, and a processor computing the new digital certificate.

The protocols may be used in several different networked computing environments. FIG. 1 is a block diagram of an exemplary network architecture. Such a network may be implemented, but is not limited to, using personal computers, workstations, mini- or mainframe computers, or a distributed networks of computers. The computers may also comprise (or use) special hardware—such as cryptographic co-processors, routers etc. The computers may also be implemented entirely based on special-purpose VLSI gates or on Field-Programmable Gate Arrays (FPGAs), or other technologies alike. For the simplicity, the network in FIG. 1 is composed using a general (simplified) model of computers configured with a processor, memory, and an Input/Output Interface. These components are tied one to another via buses. The communications network 101 can be configured using a combination of the following: ethernet, internet, intranet, wide area network, local area network, virtual private network, wireless, asynchronous transmission method, synchronous, dial-up, or distributed.

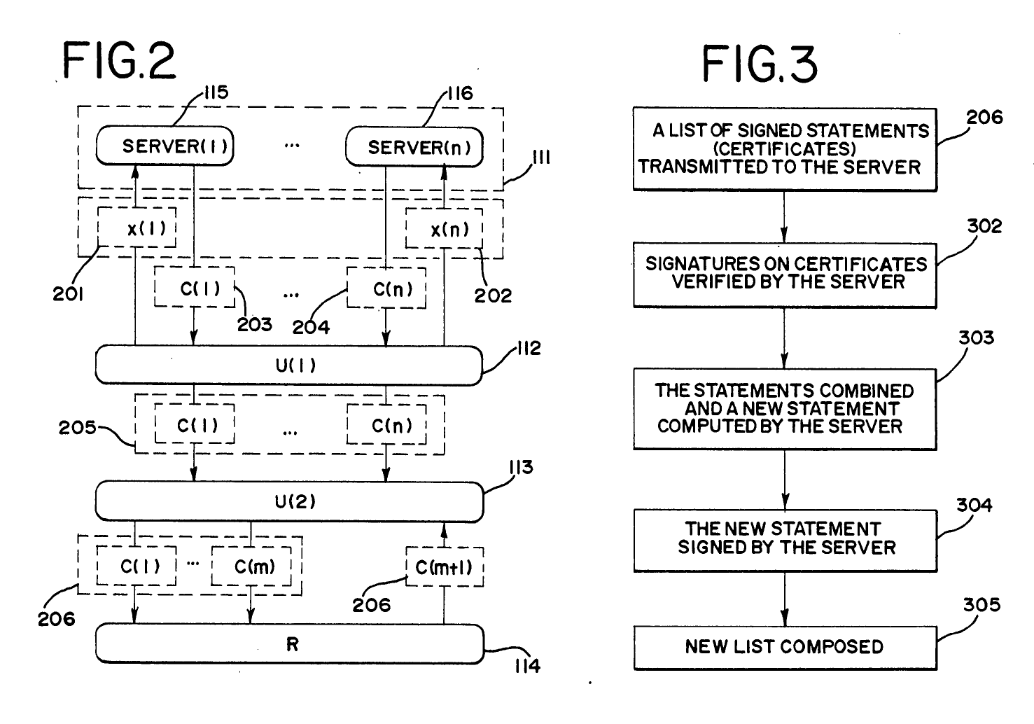

FIG. 2 depicts a message flow diagram within one system for modifying a group of certificates of the present invention. For obtaining one 203 or more certificates 204 for a user 112 initiated requestx for one 201 or more 202 certificates, chooses n servers S(1), . . . ,S(n) (denoted Server(1), . . . , Server(n) 101 ). Each originating server 115 is sent a request x 202 denoted by x(1), . . . , x(n). The originating servers 111 reply with certificates C(1), . . . , C(n), respectively.

1. ∉: U(1)→S(i):x

2. ∉: S(i)→U(1): C(i)=Signs₍ᵢ₎{Ai(x)}

As a result U(1) 112 obtains an n-tuple C(1), . . . , C(n) of certificates 204. Each certificate C(i) 203 (issued by S(i) and sent to U(1)) is a signed message C(i)=Signₛ₍ᵢ₎{Aᵢ(x)}. Before issuing a certificate 203, each server may perform some additional checking procedures such as an identity check. The certificate is then issued only after a successful check. Another user U(2) 113 who possesses a list of certificates (obtained by U(1) and then transmitted to U(2)), one certificate of which has possibly been compromised executes the following protocol:

1: U(2): chooses a list C(1), . . . , C(m) of valid certificates.

2: U(2)→R: C(1)=Signsₛ₍₁₎{A₁(x)}, . . . , C(m)=Sign_{S(m)}{Aₘ(x)}

If the signatures are valid and if x is the same in all Aᵢ(x):

3: R→U(2): C(m+1)=Sign_{R}{F[A₁(x), . . . , Aₘ(x) ]}.

According to the protocol, the renewal server R 114 verifies the signatures on C(1), . . . , C(m). If the signatures are valid, R 114 creates a new certificate C(m+1) 207 based on a computation algorithm and transmits it back to the user U(2) 113 via a communication network 101. The user U(2) 113 adds C(m+1) 207 in the list of certificates, and U(2) 113 removes invalid components from the list, if any.

FIG. 3 is a flow chart depicting one method of modifying of certificates of the present invention. The method described may be used in case one of the certificates initially sent from the originating servers 111 being stored on the user computer 112 becomes unusable. A certificate becomes unusable when the key is compromised, the certificate is corrupt, or the cryptographic scheme is broken. The method includes the steps of: (1) receiving an initial list of certificates comprising a plurality of certificates 206, (2) verifying the authenticity of each of the plurality of certificates using public keys 302, (3) computing a new certificate using a composition algorithm 303, (4) signing the new certificate 304, (5) revising the list of certificates, and (6) attaching the list, as revised, to the new certificate 305. When a certificate of a user computer 113 becomes unusable, the user U(2) may initiate the method of this invention to replace that certificate utilizing the composing steps (5) and (6) with the new certificate computed by the renewal server R 114 in steps (1), (2), (3), and (4). The method described may also be used to extend a list of signed statements by adding an additional element. In that case, the user U(2) may initiate the method of this invention to add an additional certificate computed by the renewal server R 114 in steps (1), (2), (3), and (4) utilizing the composing steps (5) and (6).

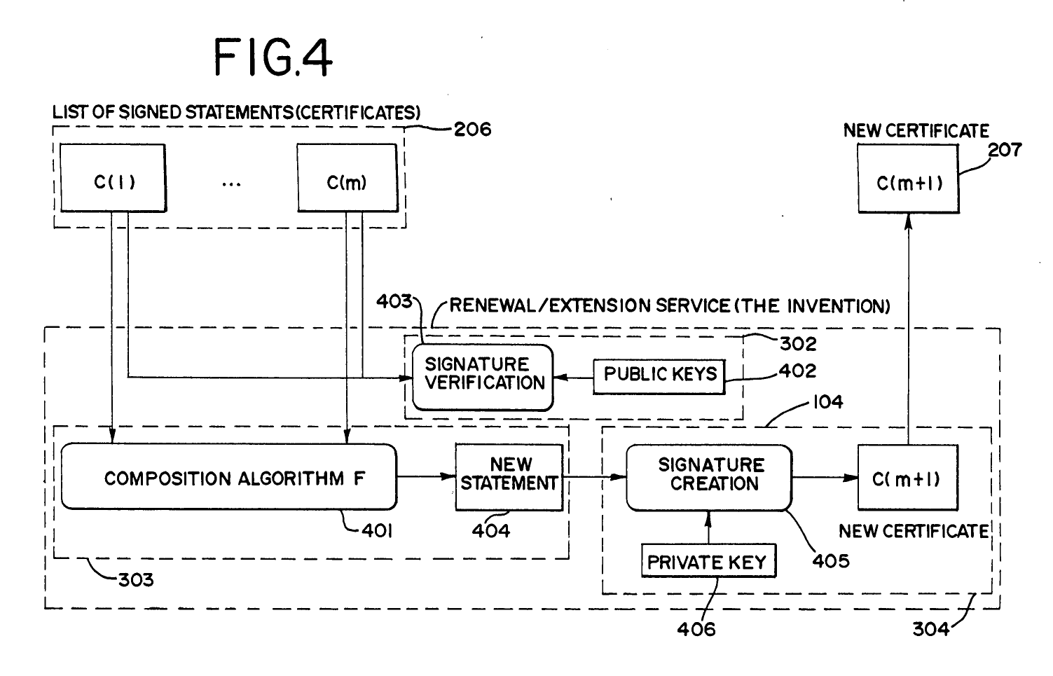

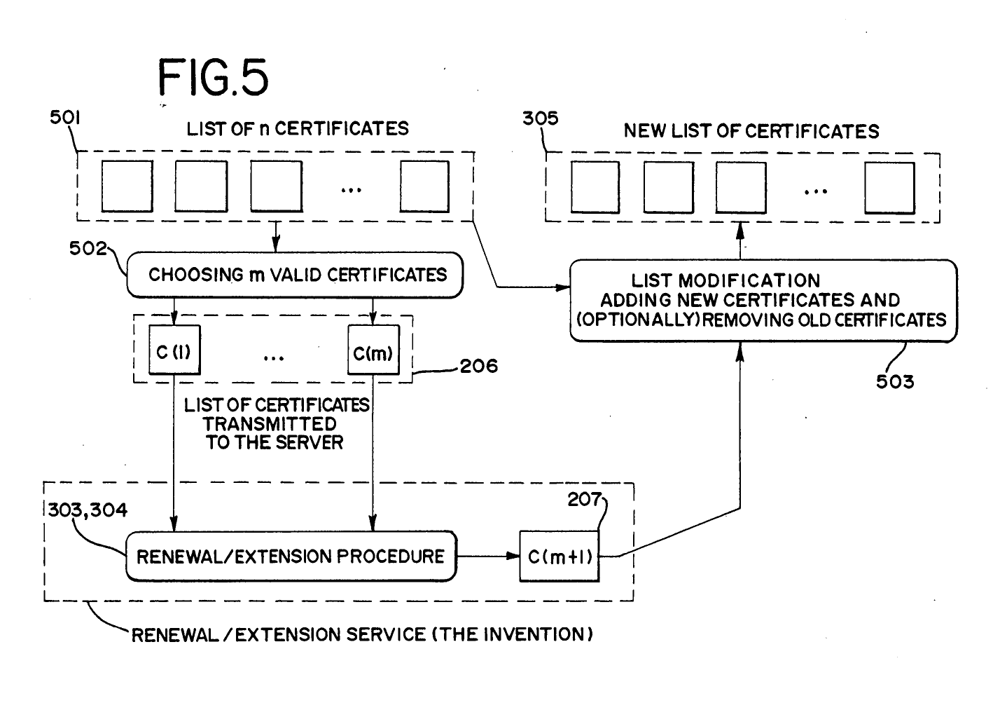

FIG. 4 is a block diagram showing one system for modifying a group of certificates of the present invention. The processor 108 of the renewal server R 206 requests a plurality (m-element list where m<n) of still valid certificates (C(1), . . . , C(m)) 206 from the user computer U(2) 113. The processor 108 of renewal server R 114 verifies the authenticity of the valid certificates 206 using a set of public keys 402 and a verification program segment 403. Once verified 302, the renewal server R 114 computes a new digital certificate using a composition algorithm F 401, by combining one or more of the validated certificates 302 received from the user computer U(2) 113. However, the composition algorithm F 401 may returns an error output which means that renewal server R 114 will not issue a new certificate. F 401 may be deterministic or probabilistic, the output of which may depend on deterministic data which the list A₁(x), . . . , A^{m}(x) does not directly comprise. In some embodiments, the computation algorithm F may further incorporate human computer interaction through an I/O device. Next, the combined statement 404 is signed 405 by the renewal server using a private key 406. The new certificate c(m+1) 207 is generated and ready for renewal or extension of the original set of certificates on the user computer U(2) 113.

FIG. 5 is another block diagram detailing the method of modifying a group of certificates of the present invention, more specifically with regards to updating the list of old certificates on the user computer U(2) 114. The processor 108 of the user computer U(2) 113 sends a plurality, m-element list (where m<n) of still valid certificates 502 to the renewal server R 114. After receiving the m-element list of certificates C(1), . . . , C(m) 206, the processor of the renewal server R 114 initiates the modification procedure 303,304. Once complete, a new digital certificate c(m+1) is generated and sent back to the user computer U(2) 113 via a communications network 101. The user U(2) 113 adds C(m+1) 207 in its list of certificates, and 113 removes any invalid components 503 from the list. The old certificate that was compromised for some reason is then replaced with the new certificate C(m+1) 207. If only one of the certificates in the list was compromised then the new list again n valid components 305 and its resistance to key compromises is the same as that of the previous certificates 501

In this section, we present some examples of services where the renewal/extension procedure is useful. The services we describe here are: (1) digital time-stamping; (2) public-key certification; (3) digital signature service; (4) certificate validation service; and (5) electronic notary service. It is however not excluded, that the renewal/extension procedure is usable in

Digital Time-Stamping

The present invention can be implemented in a digital time-stamping embodiment. Here, the statements Aⁱ(x) have a form (x, t¹) where t¹ denotes time/date the request x was received by the i-th time-stamping ser TSAᵢ. The servers may use the following composition algorithm F:

$$F [ ( {x}_{1} , {t}_{1} ) , … , ( {x}_{m} , {t}_{m} ) = \{ \begin{matrix}( {x}_{1} , {min}_{k} \{ {t}_{1} , … , {t}_{m} \} ) , if {x}_{1} = … = {x}_{m} ; \\ error otherwise ,\end{matrix}$$

where min^{k} denotes finding the k-th smallest element of the argument list. Other functions, such as (x; max{t₁, . . . tₘ) or (x; (t¹+ . . . +^{m})/m), may also be reasonable. Note that F may be defined so that it returns error if the time-values T₁, . . . , tₘ are, in some sense, too different or if they do not satisfy some other (previously fixed) relation. Public-key certification is a service which is authorized to make statements A(x) about a public key x. The service provider is often called a Certification Authority (CA). For example, A(x) may say that x belongs to a person with identity ID x. In that case, the certificate Sign_{CA}{x, IDₓ} is called identity certificate. Another example of a public-key certificate is an authorization certificate which associates a public key x with a list of access rights rₓ. In the first case, F may be defined as follows:

$$F [ {A}_{1} ( {x}_{1} ) , … , {A}_{m} ( {x}_{m} ) ] = \{ \begin{matrix}{A}_{1} , ( {x}_{1} ) , if all {A}_{i} ( {x}_{i} ) are identical ; and \\ error otherwise .\end{matrix}$$

Certificate Validation Service

The present invention can also be implemented in a certificate validation service. This is a service that certifies the validity of a digital certificate. Having received a request that comprises unique identifier c (possibly the sequence number or a cryptographic hash) of the certificate and optionally, some additional datay that may be a digital signature created using the public key listed certificate c. If the certificate is valid (not revoked), the Server signs a validation statement A=(c, y) that comprises the certificate's identifier c and the additional data y optionally included into the request. Having a list of validation statements A₁=(c₁, y₁), . . . , Aₘ=(cₘ, yₘ) the composition algorithm F is defined in the same way as in public-key certification, i.e.

$$F [ {A}_{1} ( {x}_{1} ) , … , {A}_{m} ( {x}_{m} ) ] = \{ \begin{matrix}{A}_{1} , ( {x}_{1} ) , if all {A}_{i} ( {x}_{i} ) are identical ; and \\ error otherwise .\end{matrix} v$$

Digital Signature Service

The present invention can further be implemented in a digital signature service. This service is authorized to create public-key digital signatures in the name of its users. In digital signature service, a query x is a cryptographic digest of a document x intended to be signed by the user. The query is sent to the server S in authenticated manner, i.e. some client authentication mechanism (passwords etc.) is used. If the user U is successfully authenticated, S creates a reply Sign_{S}{A(x)}, where A(x) comprises the identity IDᵤ of the user and the cryptographic digest x. Having a list of requests A₁(x₁)=(ID₁, x₁), . . . , Aₘ(xₘ)=(IDₘ, xₘ) as input, the composition algorithm F is defined in the same way as in public-key certification, i.e.

$$F [ {A}_{1} ( {x}_{1} ) , … , {A}_{m} ( {x}_{m} ) ] = \{ \begin{matrix}{A}_{1} , ( {x}_{1} ) , if all {A}_{i} ( {x}_{i} ) are identical ; and \\ error otherwise .\end{matrix}$$

Electronic Notary Service

The present invention can also be implemented in an electronic notary service. This service combines the digital signature and the time-stamping services. After obtaining a digest x in authenticated manner, the notary server S creates a notarization statement A(x)=(ID_{U}, x, t), where ID_{U} is the identity of the user and t is then current time that the server obtains from a time source. Having a list of requests A₁(x₁)=(ID₁, x₁, t₁), . . . , Aₘ(xₘ)=(IDₘ, xₘ, tₘ) as input the function F may be defined as follows

$$F [ {ID}_{1} , {x}_{1} , {t}_{1} ) , … , ( {ID}_{m} , {x}_{m ,} {t}_{m} ) ] = \{ \begin{matrix}( {ID}_{1} , {x}_{1} , {min}_{k} \{ {t}_{1} , … , {t}_{m} \} ) , \\ \begin{matrix} \\ error\end{matrix}\end{matrix} \begin{matrix}if {x}_{1} = … = {x}_{m} and \\ \begin{matrix}{ID}_{1} = … = {ID}_{m} ; \\ otherwise .\end{matrix}\end{matrix}$$

While the specific embodiments have been illustrated and described, numerous modifications come to mind without significantly departing from the spirit of the invention and the scope of protection is only limited by the scope of the accompanying Claims.

What is claimed is:

1. A system for generating a new digital certificate for a transaction, comprising:
a communication network;
a first processor connected to the communication network, wherein the first processor is in communication with a first memory for storing a first group of digital certificates;
a second processor connected to the communication network, wherein the second processor is in communication with a second memory for storing a second group of digital certificates;
a third processor connected to the communication network, the third processor for requesting at least one certificate from at least one of the first and second processors within at least one of the first and second groups of certificates, and wherein the at least one of the first and second processors is for issuing the at least one certificate; and,
a fourth processor connected to the communication network, wherein the fourth processor is in communication with a fourth memory, wherein the third processor requests the fourth processor to provide the third processor with a new certificate, and wherein the fourth processor sends the third processor the new certificate for the transaction.

2. The system of claim 1, wherein the third processor requests the fourth processor to provide the third processor with a new certificate when the at least one certificate is not useable.

3. The system of claim 1, wherein the new certificate is stored within the fourth memory.

4. The system of claim 1, wherein the new certificate is computed by the fourth processor using information associated with the at least one certificate.

5. The system of claim 1, wherein the new certificate is computed by the fourth processor using information associated with the at least one certificate, wherein the fourth processor sends the third processor the new certificate for the transaction, and wherein the a list of the at least one certificate is attached to the new certificate when the fourth processor sends the third processor the new certificate.

6. The system of claim 1, wherein the new certificate is computed on the fly by the fourth processor using information associated with the at least one certificate.

7. The system of claim 1, wherein the third processor requests a plurality of certificates from at least one of the first and second processors within at least one of the first and second groups of certificates, and wherein the first and second processors issues the plurality of certificates, and wherein the third processor requests the fourth processor to provide the third processor with a new certificate, and wherein the fourth processor computes the new certificate based on information associated with each certificate within the plurality of certificates.

8. The system of claim 1, wherein the third processor requests a plurality of certificates from at least one of the first and second processors within at least one of the first and second groups of certificates, and wherein the first and second processors issues the plurality of certificates, and wherein the third processor requests the fourth processor to provide the third processor with a new certificate, and wherein the fourth processor computes the new certificate based on information associated with more than one certificate within the plurality of certificates, but less than every certificate within the plurality of certificates.

9. The system of claim 1, wherein the new certificate is computed by the fourth processor using information relating to an interaction between a user and the third processor.

10. The system of claim 1, wherein the third processor requests a plurality of certificates from at least one of the first and second processors within at least one of the first and second groups of certificates, and wherein the first and second processors issues the plurality of certificates, and wherein the third processor requests the fourth processor to provide the third processor with a new certificate, and wherein the new certificate is added to the plurality of certificates and made a part of the plurality of certificates.

11. The system of claim 1, wherein the third processor requests a plurality of certificates from at least one of the first and second processors within at least one of the first and second groups of certificates, and wherein the first and second processors issues the plurality of certificates, and wherein the third processor requests the fourth processor to provide the third processor with a new certificate, and wherein the new certificate replaces at least one certificate within the plurality of certificates.

12. The system of claim 1, wherein the first, second and fourth processors are servers.

13. The system of claim 1, wherein at least one of the first, second and fourth processors comprise cryptographic co-processors.

14. The system of claim 1, wherein the third processor is a personal computer.

15. The system of claim 1, wherein the communication network is at least one of ethernet, internet, intranet, wide area network, local area network, virtual private network, wireless, asynchronous transmission method, synchronous, dial-up, distributed.

16. The system of claim 1, wherein the new certificate is computed by the fourth processor using information associated with the at least one certificate, wherein the fourth processor verifies the at least one certificate before computing the new certificate.

17. A method of generating a new digital certificate for a transaction, comprising the steps of:
providing for receiving a request from a user processor to send a user processor at least one certificate from at least one of a first and second group of certificates stored with first and second memory, respectively, connected to first and second processors, respectively;
providing for sending the at least one certificate to the user processor;
providing for receiving the at least one certificate at a fourth processor; and,
providing for sending from the fourth processor to the user processor a new certificate for the transaction.

18. The method of claim 17 further comprising the steps of:
providing for storing the first group of digital certificates in the first memory connected to the first processor; and,
providing for storing the second group of digital certificates is the second memory connected to the second processor.

19. The method of claim 17, wherein the first, second, user, and fourth processors would be connected to a communication network.

20. The method of claim 17, wherein the step of providing for receiving a request for the fourth processor to provide the user processor with a new certificate would be performed when the at least one certificate is not useable.

21. The method of claim 17, wherein the new certificate would be stored within the fourth memory.

22. The method of claim 17 further comprising the step of:
providing for computing the new certificate using information associated with the at least one certificate.

23. The method of claim 22, wherein the computing would be performed by the fourth processor.

24. The method of claim 23 further comprising the step of:
providing for attaching a list of the at least one certificate to the new certificate when the fourth processor sends the user processor the new certificate.

25. The method of claim 17, wherein the step of providing for receiving a request comprises providing for receiving a request for a plurality of certificates from at least one of the first and second processors, from within at least one of the first and second groups of certificates, wherein the step of providing for sending the at least one certificate comprises providing for sending the plurality of certificates to the user processor, the method further comprising the steps of:
providing for receiving a request for the fourth processor to provide the user processor with a new certificate; and,
providing for computing the new certificate based on information associated with each certificate within the plurality of certificates.

26. The method of claim 17, wherein the step of providing for receiving a request comprises providing for receiving a request for a plurality of certificates from at least one of the first and second processors, from within at least one of the first and second groups of certificates, wherein the step of providing for sending the at least one certificate comprises providing for sending the plurality of certificates to the user processor, the method further comprising the steps of:
providing for receiving a request for the fourth processor to provide the user processor with a new certificate; and,
providing for computing the new certificate based on information associated with more than one certificate within the plurality of certificates, but less than every certificate within the plurality of certificates.

27. The method of claim 17 further comprising the step of:
providing for computing the new certificate using information relating to an interaction between a user and the third processor.

28. The method of claim 17, wherein the step of providing for receiving a request comprises providing for receiving a request for a plurality of certificates from at least one of the first and second processors, from within at least one of the first and second groups of certificates, wherein the step of providing for sending the at least one certificate comprises providing for sending the plurality of certificates to the user processor, the method further comprising the steps of:
providing for receiving a request for the fourth processor to provide the user processor with a new certificate;
providing for computing the new certificate; and,
providing for sending the new certificate to the user processor for adding the new certificate to the plurality of certificates.

29. The method of claim 17, wherein the step of providing for receiving a request comprises providing for receiving a request for a plurality of certificates from at least one of the first and second processors, from within at least one of the first and second groups of certificates, wherein the step of providing for sending the at least one certificate comprises providing for sending the plurality of certificates to the user processor, the method further comprising the steps of:
providing for receiving a request for the fourth processor to provide the user processor with a new certificate;
providing for computing the new certificate; and,
providing for sending the new certificate to the user processor for replacing at least one certificate within the plurality of certificates.

30. The method of claim 17 further comprising the steps of:
providing for verifying the at least one certificate; and,
providing for computing the new certificate using information associated with the at least one certificate.

31. A computer program product for generating a new digital certificate for a transaction, comprising:
a first code segment for receiving a request from a user processor to send a user processor at least one certificate from at least one of a first and second group of certificates stored with first and second memory, respectively, connected to first and second processors, respectively;
a second code segment for sending the at least one certificate to the user processor;
a third code segment for receiving the at least one certificate at a fourth processor; and,
a fourth code segment for sending from the fourth processor to the user processor a new certificate for the transaction.

32. The product of claim 31 further comprising:
a fifth code segment for storing the first group of digital certificates in the first memory connected to the first processor; and,
a sixth code segment for storing the second group of digital certificates is the second memory connected to the second processor.

33. The product of claim 31 further comprising:
a fifth code segment for computing the new certificate using information associated with the at least one certificate.

34. The product of claim 33 further comprising:
a sixth code segment for attaching a list of the at least one certificate to the new certificate when the fourth processor sends the user processor the new certificate.

35. The product of claim 31, wherein the first code segment comprises a code segment for receiving a request for a plurality of certificates from at least one of the first and second processors, from within at least one of the first and second groups of certificates, wherein the second code step comprises a code segment for sending the plurality of certificates to the user processor, the method further comprising:
a fifth code segment for receiving a request for the fourth processor to provide the user processor with a new certificate; and,
a sixth code segment for computing the new certificate based on information associated with each certificate within the plurality of certificates.

36. The product of claim 31, wherein the first code segment comprises a code segment for receiving a request for a plurality of certificates from at least one of the first and second processors, from within at least one of the first and second groups of certificates, wherein the second code step comprises a code segment for sending the plurality of certificates to the user processor, the method further comprising:
a fifth code segment for receiving a request for the fourth processor to provide the user processor with a new certificate; and,
a sixth code segment for computing the new certificate based on information associated with more than one certificate within the plurality of certificates, but less than every certificate within the plurality of certificates.

37. The product of claim 31 further comprising:
a fifth code segment for computing the new certificate using information relating to an interaction between a user and the third processor.

38. The product of claim 31, wherein the first code segment comprises a code segment for receiving a request for a plurality of certificates from at least one of the first and second processors, from within at least one of the first and second groups of certificates, wherein the second code step comprises a code segment for sending the plurality of certificates to the user processor, the method further comprising:
a fifth code segment for receiving a request for the fourth processor to provide the user processor with a new certificate;
a sixth code segment for computing the new certificate; and, a seventh code segment for sending the new certificate to the user processor for adding the new certificate to the plurality of certificates.

39. The product of claim 31, wherein the first code segment comprises a code segment for receiving a request for a plurality of certificates from at least one of the first and second processors, from within at least one of the first and second groups of certificates, wherein the second code step comprises a code segment for sending the plurality of certificates to the user processor, the method further comprising:
a fifth code segment for receiving a request for the fourth processor to provide the user processor with a new certificate;
a sixth code segment for computing the new certificate; and,
a seventh code segment for sending the new certificate to the user processor for replacing at least one certificate within the plurality of certificates.

40. The product of claim 31 further comprising:
a fifth code segment for verifying the at least one certificate; and,
a sixth code segment for computing the new certificate using information associated with the at least one certificate.

41. A method of generating a new digital certificate for a transaction, comprising the steps of:
providing for receiving a request from a user processor to send a user processor at least one certificate from at least one of a first and second group of certificates stored with first and second memory, respectively, connected to first and second processors, respectively;
providing for sending the at least one certificate to the user processor;
providing for receiving the at least one certificate at a fourth processor; and,
providing for sending from the fourth processor to the user processor a new certificate for the transaction.

42. A method for generating a new certificate for a transaction comprising the steps of:
providing for receiving an initial list of certificates comprising a plurality of certificates;
providing for verifying the authenticity of each of the plurality of certificates;
providing for computing a new certificate using a composition algorithm;
providing for signing the new certificate;
providing for revising the list of certificates; and,
providing for attaching the list, as revised, to the new certificate.

43. The method of claim 42, wherein the plurality of certificates are digital time stamps.

44. The method of claim 42, wherein the plurality of certificates are public key certificates.

45. The method of claim 42, wherein the plurality of certificates are signed statements issued by a digital signature service, wherein the plurality of certificates each have at least one user identification and a cryptographic digest of a document.

46. The method of claim 42, wherein the plurality of certificates are signed statements issued by an electronic notary service, wherein the plurality of certificates each have at least one user identification, a cryptographic digest of a document, and time stamp.

47. The method of claim 42, wherein the new certificate comprises a digital time stamp the numerical value of which is the minimum of the corresponding values of the plurality of certificates from which the new certificate is calculated.

48. The method of claim 42, wherein the new certificate comprises a digital time stamp the numerical value of which is the maximum of the corresponding values of the plurality of certificates from which the new certificate is calculated.

49. The method of claim 42, wherein the new certificate comprises a digital time stamp the numerical value of which is the k-th smallest of the corresponding values of the plurality of certificates from which the new certificate is calculated.

50. The method of claim 42, wherein the new certificate comprises a digital time stamp the numerical value of which is the k-th largest of the corresponding values of the plurality of certificates from which the new certificate is calculated.

51. The method of claim 42, wherein the composition algorithm is deterministic and the output of which depends on deterministic data that the list of received certificates does not directly comprise.
